(19) United States
(12) Patent Application Publication
(10) Pub. No.: US 2007/0138171 A1
(43) Pub. Date: Jun. 21, 2007

(54) Microwave oven and an upper duct structure thereof

(76) Inventors: Dong Heon Lee, Kyungsangnam-do (KR); Sang Ryul Lee, Kyungsangnam-do (KR)

Correspondence Address: KED & ASSOCIATES, LLP, P.O. Box 221200, Chantilly, VA, 20153-1200, US

(21) Appl. No.: 10/575,789

(22) PCT Filed: Oct. 14, 2004
(86) PCT No.: PCT/KR04/02621

§ 371 Date: Jan. 29, 2007

(30) Foreign Application Priority Data
Oct. 16, 2003 (KR) 10-2003-0072132
Oct. 16, 2003 (KR) 10-2003-0072128

(51) Int. Cl. H05B 6/64

(52) U.S. Cl. 219/757

(57) ABSTRACT

A microwave oven includes a cavity in which food is loaded and an upper duct having a main body mounted in the cavity, a duct fixing member formed on a side of the main body and fixed on a wall of the cavity, and an inclined portion extending from an end of the main body and inclined at a predetermined angle.

### TECHNICAL FIELD

The present invention relates to a microwave oven and an upper duct of the microwave oven, and more particularly, to a microwave oven and an upper duct of the microwave oven, in which the upper duct controlling airflow in a cavity is detachably mounted in a simple structure and designed to form an air curtain using air directed from the upper duct into the cavity, which can prevent vapor generated in the cavity from contacting the door, thereby preventing water drops and steam from being formed on the door.

### BACKGROUND ART

Generally, a microwave oven is a device that is used to heat food by radiating microwave generated from a magnetron to the food when electric current is applied to electric components of the device.

Such a microwave oven is classified into a household microwave oven having a small magnetron and a commercial microwave oven having a large (or a plurality of) magnetron.

The microwave oven is further classified according to a heating method into a glass tray method rotating the food and a stirrer fan method scattering microwave radiated into the cavity. The former is generally applied to the household microwave oven while the latter is applied to the commercial microwave oven.

Since the commercial microwave oven is generally used at convenience stores where the microwave oven is frequently used and restaurants where a large amount of the food should be quickly heated, the microwave oven needs relatively high power output compared with the household microwave oven.

Meanwhile, in a prior microwave oven, an upper duct is installed on a top of the cavity in which the food to be heated is loaded. A glass tray for rotating the loaded food is installed on a bottom of the cavity.

That is, the upper duct is formed in a rectangular shape, having exhaust holes formed on a distal end to exhaust air in the cavity to an external side and blowing holes formed on a proximal end in front of the cavity to direct outer air into the cavity.

The upper duct is installed on a top of the cavity with a space defined there between. A stirrer fan is mounted in the space. Air intake holes are formed on a right wall of the cavity. Hence, the air introduced through the air intake holes flows along the upper duct and is then directed into the cavity through the blowing holes.

A process for installing the prior upper duct on the top of the cavity will be described hereinafter.

A plurality of coupling holes are formed on front and rear portions of the cavity top. A plurality of through holes corresponding to the coupling holes are provided on the front and rear portions of the upper duct. The upper duct is closely disposed on the cavity top such that the coupling holes can be aligned with the through holes. Coupling members such as screws are inserted through the aligned coupling and through holes to fix the upper duct on the cavity top.

After the above, the stirrer fan is mounted in the space defined between the cavity top and the upper duct. The stirrer fan is rotated by a synchronous motor to scatter the microwave radiated into the cavity.

However, the prior upper duct has problems as follows:

1. In order to mount or dismount the upper duct on the cavity top, a worker bends down to screw the screws into the coupling and through holes. It is troublesome for the worker to bend down. Particularly, since the through holes of the upper duct are not exposed frontward, it is not easy to screw the screws in the holes.

2. Since many screws are coupled to the holes, the assembling process is complicated, being time-consuming.

3. Since many screws are used, the manufacturing cost of the microwave oven is increased.

4. When the food loaded in the cavity is heated by the microwave, the water contained in the food is vaporized to generate steam. When the steam contacts the door, a door glass of the door is clouded up by the steam, thereby making it difficult for a user to see the cooking state of the food loaded in the cavity.

5. When the operation of the microwave oven is stopped and the temperature of the door is reduced, the steam contacting the door is phase-changed into water drops. The water drops flows down, thereby making the front bottom of the cavity become dirty.

### DISCLOSURE OF THE INVENTION

### Technical Problem

Accordingly, the present invention is directed to a microwave oven and an upper duct of the microwave oven that substantially obviate one or more of the problems due to limitations and disadvantages of the related art.

An object of the present invention is to provide an upper duct of a microwave oven, which can be assembled on a cavity top of the microwave oven through a simple assembling process.

Another object of the present invention is to provide an upper duct of a microwave oven, which can reduce the manufacturing costs by reducing the number of parts required to be assembled on a cavity top of the microwave oven.

Still another object of the present invention is to provide an upper duct of a microwave oven, which can prevent vapor generated in a cavity of the microwave oven from contacting a door, thereby preventing water drops and moisture from being formed on the door.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

### TECHNICAL SOLUTION

To achieve these and other advantages and in accordance with the purpose of the present invention, as embodied and broadly described, there is provided a microwave oven comprising: a cavity in which food is loaded; and an upper duct having a main body mounted in the cavity, a duct fixing member formed on a side of the main body and fixed on a wall of the cavity, and an inclined portion extending from an end of the main body and inclined at a predetermined angle.

According to another aspect of the present invention, there is provided a microwave oven comprising: a cavity defining a food heating space; a door for opening and closing a front wall of the cavity; and an upper duct including a main body mounted in the cavity and an air curtain forming unit for preventing steam generated in the course of heating the food from contacting the door.

According to still another aspect of the present invention, there is an upper duct of a microwave oven, comprising: a duct main body detachably mounted in a cavity of the microwave oven; a duct fixing member for fixing the duct main body on the cavity, the duct fixing member including a hook step formed on a front portion of the duct main body and a fixing projection formed on a rear portion of the duct main body; an inclined portion extending from a front end of the duct main body at a predetermined inclined angle; and an air curtain forming unit formed on an end of the duct main body, the air curtain forming unit including an air-guide hole through which outer air is directed into the cavity and an air-guide for directing the air from the air-guide hole rearward of the cavity, the air-guide having a [symbol] -shaped section.

According to still yet another aspect of the present invention, there is provided an upper duct of a microwave oven having a cavity and a door for opening and closing an opening of the cavity, the upper duct comprising: a duct main body mounted on a top of the cavity; a duct fixing portion formed on a flange portion of the duct main body; and an air curtain forming unit formed on an end of the duct main body to prevent water drops from forming on the door, wherein the upper duct is mounted by inserting a hook step in a front wall of the cavity after inserting a fixing projection in a rear wall of the cavity and is dismounted by removing the fixing projection from the rear wall of the cavity after the hook step is removed from the front wall of the cavity.

### ADVANTAGEOUS EFFECTS

According to the present invention, it is easy for the worker to mount an upper duct on a cavity top.

In addition, the mounting time of the upper duct on the cavity top can be saved.

Since special coupling members are not required, the manufacturing costs can be saved.

Since steam generated from the food in the cavity cannot contact the door by the air curtain directed from the upper duct into the cavity, the door is not clouded and the water drops are not formed on the door.

Since the door is not clouded, the user can easily object the cooking state of the food.

Since the steam does not contact the door, no water drop phase-changed from the steam is formed on the door, thereby preventing the cavity bottom from becoming dirty.

That is, the microwave oven can be maintained in a clean state.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an outer perspective view of a microwave oven with an upper duct according to the present invention;

FIG. 2 is an inner perspective view of a microwave oven with an upper duct according to the present invention;

FIG. 3 is a perspective view of a bottom of an upper duct according to an embodiment of the present invention; and

FIG. 4 is a perspective view of an air guide portion of an upper duct according to an embodiment of the present invention.

### BEST MODE

Reference will now be made in detailed to the preferred embodiment of the present invention, examples of which are illustrated in the accompanying drawings. It will be apparent to those in the art that various modification and variations can be made in the present invention. Thus, it is intended that the present invention covers the modification and variations of this invention provided they come within the scope of the appended claims and their equivalents.

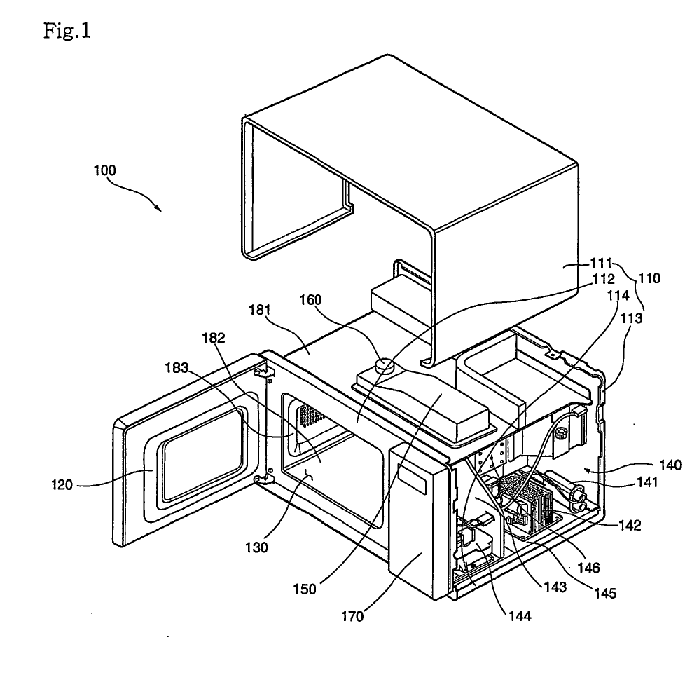

FIG. 1 shows an outer appearance of a microwave oven with an upper duct according to an embodiment of the present invention.

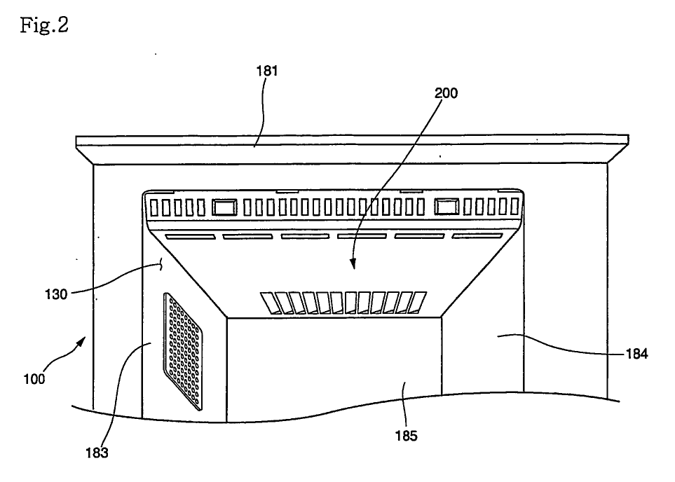

Referring to FIG. 1, the inventive microwave oven 100 includes an outer case 110 defining an outer appearance, an electric component chamber 140 protected by the outer case 110 and receiving a plurality of electric components, a cavity 130 in which food to be heated is loaded, an upper duct 200 (see FIG. 2) mounted on a top of the cavity 130 and a door 120 installed on a front portion of the cavity 130.

That is, the outer case 110 functions to define the outer appearance of the microwave oven and to protect the cavity 130 installed the rein. Accordingly, it is preferable that the outer case 110 is formed of a steel plate having predetermined strength.

The outer case 110 is installed around the cavity 130, including an upper cover 111 covering the top and both sides of the cavity 130, a base cover 114 covering a bottom of the cavity 130, a front cover defining a front portion of the cavity 130, and a back cover 113 protecting a rear portion of the cavity 130. The door 120 is mounted on the front portion of the front cover 112. Provided on a side portion of the door 120 is a control panel 170 for inputting operation conditions of the microwave oven 100.

In addition, the cavity 130 is a space in which food is heated, which is formed in a rectangular box shape having a front opening. The food is loaded and uploaded in and from the cavity 130 through the front opening. The front opening is closed and opened by the door 120.

The cavity 130 is defined by assembling top, left, right (see FIG. 2), bottom, and rear plates 181, 183, 184, 182, and 185. A waveguide for direction microwave generated by a magnetron into the cavity 130 is mounted on an outer circumference of the upper plate 181. A synchronousmotor 160 for driving a stirrer fan is mounted on a side of the waveguide 150. The stirrer fan is mounted between the upper plate 181 and the upper duct 200 (see FIG. 2) mounted under the upper plate 181.

The waveguide 150 is installed on an outer lower portion of the cavity 130 as well as the outer upper portion of the cavity, thereby radiating the microwave upward and downward in the cavity 130.

The electric component chamber 140 is a space defined on an inner side of the outer case 110 at left or right side of the cavity 130 to receive a plurality of electric components driving the microwave oven 100.

Disposed in the electric component chamber 30 are a magnetron 146 for generating the microwave, a transformer 142 boosting voltage and applying the same to the magnetron 146, a blower fan 144 for cooling down electric components heated during the generation of the microwave, and a capacitor 141 charging electric charges being applied to the transformer.

The electric component chamber is divided into two sections by a vertical barrier 143 by which the transformer 142 and the blower fan 144 are isolated from each other. The transformer 142, the blower fan 144, the capacitor 141 and the vertical barrier 143 are fixed on a top of a sub-plate 145 that is installed above the base cover 114.

That is, the transformer 142 and the magnetron 146 function to generate the microwave radiated into the cavity 130, in the course of which the electric components are heated to increase an interior temperature of the electric component chamber 130 during heating the food.

In order to cool down the heated electric components, outer air is introduced into the electric component chamber 130 by the blower fan 144.

The operation of the above-described microwave oven 100 will be described hereinafter.

After loading the food into the cavity 130 and closing the door 120, the user inputs an operation time and a heating mode using the control panel 130. Then, when the start button is turned on, electric power is applied to the electric components installed in the electric component chamber 140 to generate the microwave from the magnetron 146. The generated microwave is directed into the cavity 130 through the waveguide 150. The microwave directed into the cavity 130 is diffused and reflected by the rotation of the stirrer fan mounted on the upper and lower portions of the cavity 130 to uniformly heat the food loaded in the cavity 130.

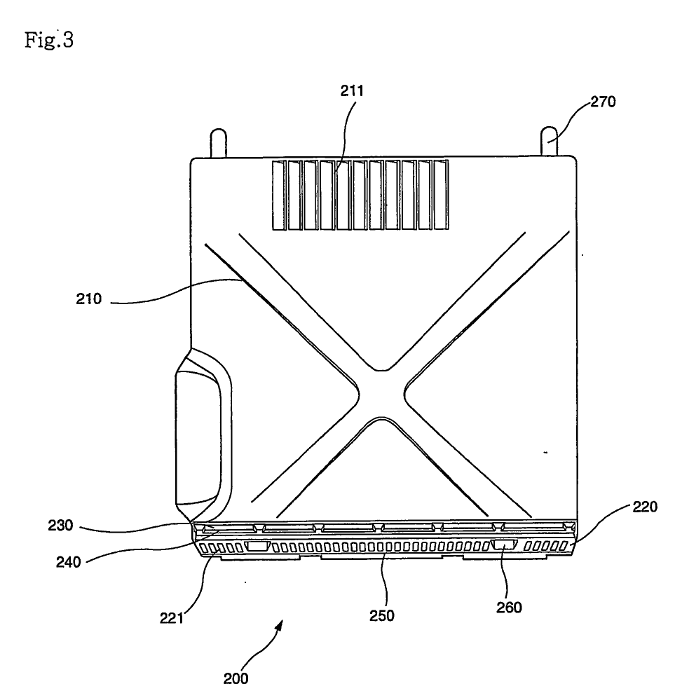

FIG. 2 shows an inner perspective view of the microwave oven with the upper duct according to the present invention and FIG. 3 shows a perspective view of a bottom of an upper duct according to an embodiment of the present invention.

Referring to FIGS. 2 and 3, the upper duct 200 is mounted on the top plate 181 defining the top of the cavity 130.

That is, the upper duct 200 includes a rectangular main body 210 and an inclined portion formed at a front portion of the main body 210 and inclined upward at a predetermined angle. The upper duct 200 further includes one or more air exhaust holes 211 formed on a rear portion of the main body 210 to exhaust high temperature air to an external side, one or more longitudinal air blowing holes 421, and grasping holes 260 the user can grasp to mount and dismount the upper duct 200.

The upper duct 200 further includes air-guide holes 230 formed between the main body 210 and the inclined portion 220 to direct air from the external side into the cavity and air-guides 240 for directing air rearward in the cavity 130.

In addition, the cavity 130 is provided at a right wall with an air intake hole (not shown) through which air can be directed from the electric component chamber 130 toward the cavity 130. The cavity 130 is provided at a top with one or more air exhaust hole (not shown) corresponding to the air exhaust hole 211 so that the air exhausted through the air exhaust hole 211 can be exhausted out of the cavity 130.

The air introduced through the air intake hole of the cavity 130 is directed to a space defined between the upper plate 181 and the upper duct 200. Accordingly, the air introduced through the air intake hole of the cavity 130 is guided by the upper duct 100 and then directed into the cavity by a stirrer fan (not shown) disposed between the top of the cavity 130 and the upper duct 200.

The main body 210 is provided at a rear end with one or more fixing projections 270 and the inclined potion 220 is provided at a front end with a hook step 250. The exhaust holes 211 is inclined at a predetermined angle to prevent the air exhausted through the exhaust hole 211 from flowing backward.

The blowing holes 221 are formed along the inclined portion 220 to direct the air introduced through the air intake hole of the cavity 130 into the cavity 130 when the upper duct 200 is mounted on the top of the cavity 130. At this point, the air being directed into the cavity 130 is directly directed to a surface where the front portion of the cavity 130 contacts the door 120.

The grasping holes 160 formed between the blowing holes 221 are provided to make it easy to mount or dismount the upper duct 100. Preferably, the grasping holes 160 are formed on left and right portions of the inclined portion 220. The air-guide holes 230 are arranged from a left end of the upper duct 200 to a right end of the upper duct 200. Each of the air-guide holes 230 is formed in a rectangular shape to vertically penetrate the upper duct 200. The air-guides 230 are formed around the respective guide holes 230 so as to guide the direction of the air directed from the air-guide holes 230.

Meanwhile, the stirrer fan installed between the upper duct 200 and the top of the cavity 130 functions to scatter the microwave radiated into the cavity 130. Hence, the scattered microwave is directed into the cavity 130 after permeating the upper duct 100. In order to allow the microwave to permeate the upper duct 100, the upper duct 200 is preferably formed of synthetic resin.

That is, the upper duct 200 is manufactured through an injection molding process using the synthetic resin material. At this point, the mold for forming the upper duct 200 is manufactured to form the fixing projections 270, the hook steps 250 and the grasping holes 260.

The air flow in a state where the upper duct 200 is mounted on the cavity 130 will be described hereinafter.

As described above, the air intake holes are formed on the right wall of the cavity 130 to direct the air from the electric component chamber 140 to the space defined between the top of the cavity 130 and the upper duct 200. The air directed into the space flows toward the front portion of the upper duct 200 by the stirrer fan. A portion of the air directed to the front portion of the upper duct is directed to the door side through the blowing holes 221 of the upper duct 200, and the rest is directed downward through the air-guide holes 230. At this point, the air directed through the air-guide holes 230 is deflected toward the rear portion of the cavity 130 at a predetermined angle by the shape of the air-guides 250.

In addition, in the course of radiating the microwave to the food loaded in the cavity 130, the air in the cavity 130 is heated and then exhausted out of the cavity 200 through the air exhaust holes formed on the top of the cavity 130. The exhaust of the air out of the cavity 130 means that it is exhausted out of the microwave oven.

The process for mounting or dismounting the upper duct 200 on the tope of the cavity 130 will be described hereinafter.

As described above, the fixing projections 270 are formed on the both sides of the rear end of the main body 210 and the hook steps 250 are formed on the front end of the inclined portion 220. Rear fixing holes for receiving the fixing projections are formed on the back plate 185 of the cavity 130. Front fixing holes for receiving the hook steps 250 are formed on the front cover 112 of the cavity 130.

Accordingly, in order for the user to mount the upper duct 200 on the top of the cavity 130, the user grasps the grasping holes 260 such that the fixing projections 270 is oriented rearward and inserts the upper duct 200 into the cavity 130. Then, when the user inserts the fixing projections 270 into the rear fixing holes formed on the back plate 185 of the cavity 130, the rear side of the upper duct 200 is fixed on the rear portion of the cavity 130.

In this state, when the user pushes the front portion of the upper duct 200, the hook steps 250 are one-touch-fixed on the front portion of the cavity 130.

As described above, when the upper duct 100 is fixed on the front cover 112, the upper duct 200 is easily fixed on the top of the cavity 130 without any special coupling members such as screws.

When the upper duct 200 fixed on the cavity 130 becomes dirty, the user can dismount the upper duct 200 from the cavity 130 to clean the upper duct 200. In order to dismount the upper duct 200, the user can use the grasping holes.

That is, in a state where the upper duct 200 is installed on the top of the cavity 130, the grasping holes are oriented frontward. That is, when the user opens the door 120, the grasping holes 260 is exposed frontward. In this state, the user inserts his/her fingers into the grasping holes 260, pushes the upper duct 200 rearward, and further pushes the upper duct 200 downward to remove the hook steps 250 from the front fixing holes. In this state, when the user pulls the upper duct 200 frontward, the fixing projections 270 are removed from the rear fixing holes, thereby dismounting the upper duct 200 from the top of the cavity 130.

As described above, the dismounting of the upper duct 200 is realized in a reverse process to that for the mounting the upper duct 200. That is, in the dismounting process, the hook steps 250 are first removed and then the fixing projections are removed. In the mounting process, the fixing projections 270 are first inserted and then the hook steps 250 are inserted.

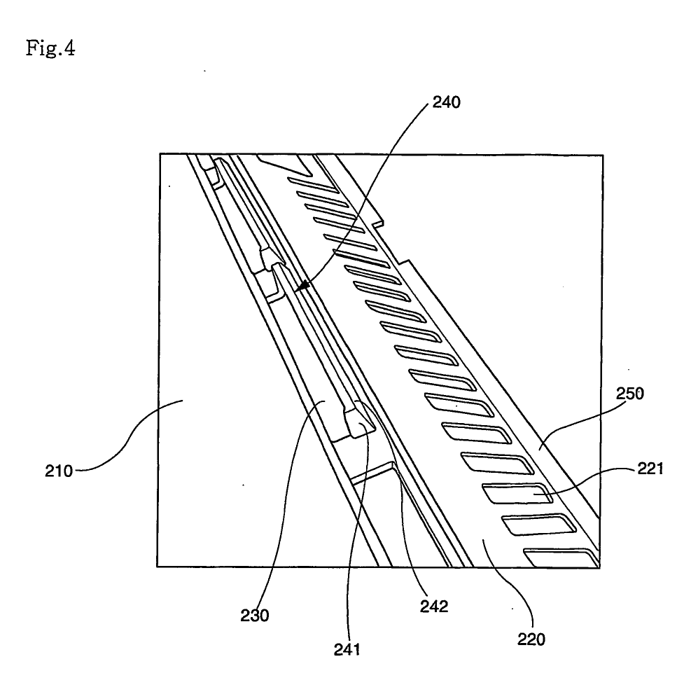

FIG. 4 is a perspective view illustrating the air-guide portion of the upper duct.

Referring to FIG. 4, the air-guide holes 230 and the air-guides 240 are formed on a border between the main body 210 and the inclined portion 220.

The air-guide holes are formed penetrating the main body 210 of the upper duct in a rectangular shape. The air-guides 230 are formed around the respective air-guide holes 230.

Meanwhile, the air-guides 240 are formed extending from the main body 210 downward and having a [symbol] -shaped section. Describing in more detail, each of the air-guides 240 includes an inclined rib 242 extending downward from the main body 210 to a predetermined height and a bent rib 241 bent from both ends of the inclined rib 242 rearward of the upper duct 200. The inclined rib 242 and the bent rib 241 are integrally formed with each other. The inclined rib 241 is inclined rearward at a predetermined angle with reference to a vertical surface perpendicular to the main body 210. Hence, the air directed through the air-guide holes 230 are directed rearward of the cavity 130 by the inclined angle of the inclined ribs 242.

According to the feature of the present invention, the upper duct 200 is one-touch-fixed on the top of the cavity 130 through the fixing projections 270 and the hook steps 250.

In addition, by the shape of the air-guides 240, when the air is directed from the upper duct 200 into the cavity 130, the air can be directed downward in the cavity 130, thereby functioning as an air curtain. That is, the vapor generated from the food in the cavity 130 cannot contact the door by the air directed from the upper duct 200 into the cavity 130, thereby preventing the water drops from being formed on the door.

### INDUSTRIAL APPLICABILITY

The upper duct and the microwave oven with the upper duct have industrial applicability as they have many advantages as follows:

1. since it is easy for the worker to mount the upper duct on the cavity top, the mounting time of the upper duct on the cavity top and the manufacturing costs can be saved.

2. Since steam generated from the food in the cavity cannot contact the door by the air curtain directed from the upper duct into the cavity, the door is not clouded and the water drops are not formed on the door. Accordingly, the door is not clouded, the user can easily object the cooking state of the food.

3. Furthermore, Since the steam does not contact the door, no water drop phase-changed from the steam is formed on the door, thereby preventing the cavity bottom from becoming dirty. Accordingly, the service life of the microwave oven can be increased.

1. A microwave oven comprising:
a cavity in which food is loaded; and
an upper duct having a main body mounted in the cavity, a duct fixing member formed on a side of the main body and fixed on a wall of the cavity, and an inclined portion extending from an end of the main body and inclined at a predetermined angle.

2. The microwave oven according to claim 1, wherein the upper duct is formed of synthetic resin material.

3. The microwave oven according to claim 1, wherein the duct fixing member includes a hook step formed on a front portion of the upper duct.

4. The microwave oven according to claim 1, wherein the duct fixing member includes a hook step extending from an end of the inclined portion to allow the upper duct to be fixed on the front wall of the cavity.

5. The microwave oven according to claim 1, wherein the duct fixing member includes one or more fixing projections extending from a rear end of the upper duct.

6. The microwave oven according to claim 1, wherein the duct fixing member includes one or more fixing projections extending from a rear end of the upper duct to allow the upper duct to be fixed on a rear wall of the cavity.

7. The microwave oven according to claim 1, wherein the duct fixing member is integrally formed with the main body.

8. The microwave oven according to claim 1, wherein the inclined portion is provided with one or more grasping portions a user can grasp.

9. The microwave oven according to claim 1, wherein the cavity is provided at a rear wall with an insertion groove in which the duct fixing member can be inserted.

10. The microwave oven according to claim 1, wherein the cavity is provided at a front wall with an insertion groove in which the duct fixing member can be inserted.

11. A microwave oven comprising:
a cavity defining a food heating space;
a door for opening and closing a front wall of the cavity; and
an upper duct including a main body mounted in the cavity and an air curtain forming unit for preventing steam generated in the course of heating the food from contacting the door.

12. The microwave oven according to claim 11, wherein the air curtain forming unit is formed on a front portion of the upper duct.

13. The microwave oven according to claim 11, wherein the air curtain forming unit comprising:
one or more air-guide holes each formed in a rectangular shape; and
an air-guide for directing air at a predetermined inclined angle into the cavity through the air-guide holes.

14. The microwave oven according to claim 11, wherein the air curtain forming unit comprising:
an air-guide hole through which air is directed into the cavity; and
an air-guide formed around the air-guide hole and extending downward, the air-guide being inclined rearward of the cavity.

15. The microwave oven according to claim 14, wherein the air-guide has a [symbol] -shaped section.

16. The microwave oven according to claim 15, wherein the upper duct is detachably mounted on a top of the cavity.

17. An upper duct of a microwave oven, comprising:
a duct main body detachably mounted in a cavity of the microwave oven;
a duct fixing member for fixing the duct main body on the cavity, the duct fixing member including a hook step formed on a front portion of the duct main body and a fixing projection formed on a rear portion of the duct main body;
an inclined portion extending from a front end of the duct main body at a predetermined inclined angle; and
an air curtain forming unit formed on an end of the duct main body, the air curtain forming unit including an air-guide hole through which outer air is directed into the cavity and an air-guide for directing the air from the air-guide hole rearward of the cavity, the air-guide having a [symbol] -shaped section.

18. The upper duct according to claim 17, wherein the inclined portion is provided with one or more grasping portion a user can grasp.

19. The upper duct according to claim 17, wherein the inclined portion is provided with one or more blowing holes through which outer air is directed into the cavity.

20. An upper duct of a microwave oven having a cavity and a door for opening and closing an opening of the cavity, the upper duct comprising:
a duct main body mounted on a top of the cavity;
a duct fixing portion formed on a flange portion of the duct main body; and
an air curtain forming unit formed on an end of the duct main body to prevent water drops from forming on the door,
wherein the upper duct is mounted by inserting a hook step in a front wall of the cavity after inserting a fixing projection in a rear wall of the cavity and is dismounted by removing the fixing projection from the rear wall of the cavity after the hook step is removed from the front wall of the cavity.
